(19) United States
(12) Patent Application Publication
(10) Pub. No.: US 2009/0084988 A1
(43) Pub. Date: Apr. 2, 2009

(54) SINGLE WAFER IMPLANTER FOR SILICON-ON-INSULATOR WAFER FABRICATION

(75) Inventors: Julian Blake, Gloucester, MA (US); Yuri Erokhin, Newburyport, MA (US); Jonathan England, Horsham (GB)

Correspondence Address: VARIAN SEMICONDUCTOR EQUIPMENT ASSC., INC., 35 DORY RD., GLOUCESTER, MA, 01930-2297, US

(73) Assignee: VARIAN SEMICONDUCTOR EQUIPMENT ASSOCIATES, INC., Gloucester, MA (US)

(21) Appl. No.: 11/862,810

(22) Filed: Sep. 27, 2007

(51) Int. Cl. G21K 5/08

(52) U.S. Cl. 250/492.21

(57) ABSTRACT

An ion implanter is disclosed. One such ion implanter includes an ion beam source configured to generate oxygen, nitrogen, helium, or hydrogen ions into an ion beam with a specific dose range, and an analyzer magnet configured to remove undesired species from the ion beam. The ion implanter includes an electrostatic chuck having a backside gas thermal coupling that is configured to hold a single workpiece for silicon-on-insulator implantation by the ion beam and is configured to cool the workpiece to a temperature in a range of approximately 300° C. to 600° C.

### FIELD

This invention relates to ion implantation and, more particularly, to single wafer beamline ion implanters for silicon-on-insulator implants.

### BACKGROUND

Ion implantation is a standard technique for introducing conductivity-altering impurities into semiconductor wafers. A desired impurity material is ionized in an ion source, the ions are accelerated to form an ion beam of prescribed energy, and the ion beam is directed at the surface of the wafer. The energetic ions in the beam penetrate into the bulk of the semiconductor material and are embedded into the crystalline lattice of the semiconductor material to form a region of desired conductivity.

An ion implanter includes an ion source for converting a gas or a solid material into a well-defined ion beam. The ion beam typically is mass analyzed to eliminate undesired ion species, accelerated to a desired energy, and implanted into a target. The ion beam may be distributed over the target area by electrostatic or magnetic beam scanning, by target movement, or by a combination of beam scanning and target movement. The ion beam may be a spot beam or a ribbon beam having a long dimension and a short dimension. For a ribbon beam, the long dimension usually is at least as wide as the wafer.

Silicon-on-insulator (SOI) is a layered semiconductor structure consisting generally of a silicon substrate with an internal insulating layer. The insulating layer disposed within the substrate may be, for example, SiO₂ or SiN. SOI reduces the time required to charge or discharge a transistor, reduces capacitance at the source and drain junctions, and may be used to reduce circuit size.

One way of fabricating an SOI is separation by implantation of oxygen (SIMOX). SIMOX usually utilizes ion beam implantation and annealing to form the silicon dioxide layer. The wafer is heated before the oxygen implantation to retain its crystalline structure during implant. Oxygen is then implanted into the wafer and the wafer is annealed to form a SiO₂ layer. A high temperature anneal may then be performed. In some embodiments, silicon deposition is performed to create an SOI wafer.

Separation by implantation of nitrogen (SIMON) is performed in a similar manner to SIMOX using nitrogen instead of oxygen. Nitrogen ions may form, for example, Si₃N₄, which is a good insulator, or may be combined with oxygen ions during implant.

Another way of fabricating an SOI is through a “bond and cleave” process. A donor wafer is oxidized to form an insulating layer. Hydrogen, helium, or a combination of hydrogen and helium is implanted into the donor wafer. The donor wafer is then inverted and is bonded to another wafer, known as a handle, so that the implanted surface of the donor wafer is disposed on the handle wafer. The hydrogen or helium forms bubbles or pockets within the donor wafer during the implant. Thus, the donor wafer may be cleaved, or have the non-implanted portion separated from the implanted portion.

Plasma immersion has been used for SOI implantation. Plasma immersion typically uses an RF plasma source to generate ions as seen in, for example, U.S. Pat. No. 6,207,005 issued to Henley et al. However, plasma immersion lacks a mass selection magnet so ion selection is difficult. Furthermore, it is difficult to maintain dose uniformity during implant.

Spinning disk batch implanters may likewise be used for SOI implantation. However, if there is any error during processing in a batch implanter, the entire batch of wafers or workpieces may be ruined, instead of just a single wafer or workpiece. Wafers are typically expensive and such a mistake in a batch implanter would be very costly.

Single wafer beamline implanters offer numerous advantages not found in a spinning disk batch implanter or plasma immersion system. A two magnet beamline, for example, is very important for ion selection. Some beam shapes within a single wafer implanter further offer a higher throughput because these beam shapes have a broader beam and better transport at high beam currents. Single wafer implanters also provide improved heat load distribution onto a wafer.

Single wafer implanters for SOI implantation previously had a very small beam area, small beam current, and lacked high throughput or temperature control of the wafer or workpiece. Thus, implants, in some cases, may have taken days to complete because throughput was very low for such implanters.

Accordingly, there is a need in the art for a new and improved apparatus and method of single wafer beamline ion implantation for silicon-on-insulator implants.

### SUMMARY

According to a first aspect of the invention, an ion implanter is provided. The ion implanter comprises an ion beam source configured to generate ions selected from a group consisting of oxygen and nitrogen into an ion beam with a dose range selected from a group consisting of oxygen at approximately 1E17 to 4E17 cm⁻², oxygen at approximately 1 to 3E15 cm⁻², and nitrogen at approximately 1E17 to 2E18 cm⁻²; an analyzer magnet configured to remove undesired species from the ion beam; and an electrostatic chuck having a backside gas thermal coupling, the electrostatic chuck configured to hold a single workpiece for silicon-on-insulator implantation by the ion beam with the dose range, the electrostatic chuck configured to cool the workpiece to a temperature in a range of approximately 300° C. to 600° C.

According to a second aspect of the invention, an ion implanter is provided. The ion implanter comprises an ion beam source configured to generate ions selected from a group consisting of hydrogen and helium into an ion beam having a dose range selected from the group consisting of hydrogen at approximately 5E15 to 8E16 cm⁻² and helium at approximately 5E15 to 8E16 cm⁻²; an analyzer magnet configured to remove undesired species from the ion beam; and an electrostatic chuck having a backside gas thermal coupling, the electrostatic chuck configured to hold a single workpiece for silicon-on-insulator implantation by the ion beam with the dose range, the electrostatic chuck configured to cool the workpiece to a temperature in a range of approximately 300° C. to 600° C.

According to a third aspect of the invention, a method for silicon-on-insulator implantation in a single wafer ion implanter is provided. This method for silicon-on-insulator implantation in a single wafer implanter comprises generating an ion beam selected from a group consisting of hydrogen at a dose of approximately 5E15 to 8E16 cm⁻², helium at a dose of approximately 5E15 to 8E16 cm⁻², oxygen at a dose of approximately 1E17 to 4E17 cm⁻², oxygen at a dose of approximately 1 to 3E15 cm⁻², and nitrogen at a dose of approximately 1E17 to 2E18 cm⁻²; analyzing the ion beam to remove undesired species; substantially retaining a single workpiece for silicon-on-insulator fabrication on an electrostatic chuck having backside gas thermal coupling; implanting the single workpiece with the ion beam; and cooling the single workpiece to a temperature in a range of approximately 300° C. to 600° C. using the electrostatic chuck.

### BRIEF DESCRIPTION OF THE DRAWINGS

For a better understanding of the present disclosure, reference is made to the accompanying drawings, which are incorporated herein by reference and in which:

FIG. 1 is an embodiment of a single wafer ion implanter;

FIG. 2 is an embodiment of an indirectly heated cathode;

FIG. 3 is an embodiment of a microwave ion source;

FIG. 4 shows an embodiment of an electrostatic chuck;

FIG. 5 is an example of a comparison of temperature to gas pressure for a chuck with backside gas;

FIG. 6 is an embodiment of a chuck capable of performing backside gas thermal coupling; and

FIG. 7 is an embodiment of an apparatus using lamps to heat a wafer.

### DETAILED DESCRIPTION

The invention is described herein in connection with an ion beam implantation apparatus and method. However, the invention can be used with other systems and processes involved in semiconductor manufacturing. Thus, the invention is not limited to the specific embodiments described below.

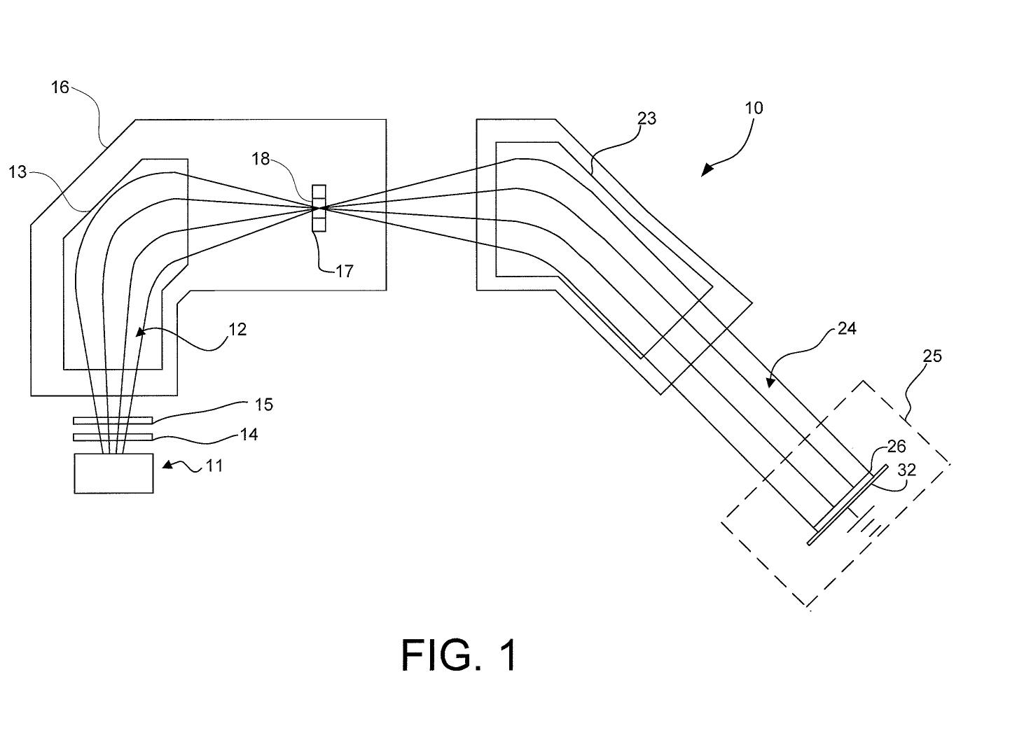

FIG. 1 is an embodiment of a single wafer ion implanter. In general, the single wafer ion implanter 10, such as a VIISta HC implanter manufactured by Varian Semiconductor Equipment Associates of Gloucester, Mass., includes ion beam source 11 to generate an ion beam 12. Ion beam source 11 may include an ion chamber and a gas box containing a gas to be ionized. Ion beam source 11 may be an indirectly heated cathode, a microwave ion source, or an RF ion source. The gas is supplied to the ion chamber where it is ionized. The ions thus formed are extracted from the ion chamber to form ion beam 12.

Ion beam 12 passes through suppression electrode 14 and ground electrode 15 to mass analyzer 16. Mass analyzer 16 includes resolving magnet 13 and masking electrode 17 having resolving aperture 18. Resolving magnet 13 deflects ions in ion beam 12 such that ions of a desired ion species pass through resolving aperture 18. Undesired ion species do not pass through resolving aperture 18, but are blocked by masking electrode 17. In one embodiment, resolving magnet 13 deflects ions of the desired species by approximately 90°.

Ions of the desired ion species pass through resolving aperture 18 to angle corrector magnet 23. In some embodiments, ions of the desired species also pass through a deceleration stage. Angle corrector magnet 23 deflects ions of the desired ion species and converts the ion beam from a diverging ion beam to ribbon beam 24, which has substantially parallel ion trajectories. In one embodiment, angle corrector magnet 23 deflects ions of the desired ion species by approximately 70°.

Ion beam 12 may in some embodiments pass through an acceleration column. This acceleration column selectably controls the energy of ion beam 12 and assists in causing desired concentration and penetration of ion beam 12 into workpiece 26. Ribbon beam 24 may also pass through an acceleration column in some embodiments. In other embodiments, such as for hydrogen implants where maximum energy may be approximately 60 keV, no acceleration column may be required.

In one particular embodiment, an acceleration column may be located after resolving aperture 18 and mass analyzer 16. For oxygen implants, where maximum energy may be approximately 200 keV, such an acceleration column may be required. Such an acceleration column for oxygen implants will be configured for the required current capacity and high voltage power supply. In another particular embodiment, an acceleration column is located after angle corrector magnet 23.

Ribbon beam 24 may have sufficient beam current to allow implants at production-level throughputs with a dose range of, for example, approximately 1E17 to 4E17 cm⁻² for oxygen, approximately 1 to 3E15 cm⁻² for oxygen, approximately 1E17 to 2E18 cm⁻² for nitrogen, approximately 5E15 to 8E16 cm⁻² for hydrogen, and approximately 5E15 to 8E16 cm⁻² for helium. Ribbon beam 24 may also have sufficient beam current to allow implants at production-level throughputs with a dose range of approximately 1 to 3E15 cm⁻² for an oxygen damage implant, for example. Two specific doses for ribbon beam 24 may be, for example, about 5E16 cm⁻² for H+ implant or about 2E17 cm⁻² for an O+ implant. Energies for O+ implants may have to be at least approximately 80 keV in most applications.

End station 25 supports a workpiece, such as workpiece 26, in the path of ribbon beam 24 such that ions of the desired species are implanted into workpiece 26. Workpiece 26 may be, for example, a wafer or another object requiring ion implantation. Workpiece 26 is typically implanted, in these embodiments, for SOI.

End station 25 may support other workpieces for implantation besides workpiece 26. End station 25 may include chuck 32 to support workpiece 26. Some embodiments of end station 25 may also include a scanner for moving workpiece 26 perpendicular to the long dimension of the ribbon beam 24 cross-section or performing other one-dimensional scans, thereby distributing ions over the entire surface of workpiece 26. Chuck 32 may also be configured to rotate and provide orthogonal scan correction in some embodiments.

In other embodiments, chuck 32 may be configured to perform quad implants. Quad implants typically mean that the workpiece 26 is rotated 90° after each quarter of the dose to help shadow PR features. Quad implants may also be used in SOI applications to wash out any right-to-left gradient.

Ribbon beam 24 may be at least as wide as workpiece 26. Although ribbon beam 24 is illustrated, other ion implanter embodiments may provide a scanned ion beam (scanned in one or two dimensions) or may provide a fixed ion beam. The ion implanter may also include a second deceleration stage positioned downstream of angle corrector magnet 23 in some embodiments.

The ion implanter may include additional components known to those skilled in the art. For example, end station 25 typically includes automated workpiece handling equipment for introducing workpieces into the ion implanter and for removing workpieces after ion implantation. End station 25 may also include a dose measuring system, an electron flood gun, and other known components. It will be understood to those skilled in the art that the entire path traversed by the ion beam is evacuated during ion implantation.

A single-wafer ion implanter, such as that illustrated in FIG. 1, may be used for SOI implantation. Single-wafer ion implanters, such as single wafer ion implanter 10, can perform, for example, hydrogen, helium, oxygen, and nitrogen implants. In some embodiments, hydrogen and helium or oxygen and nitrogen are implanted together. This can either be to form an insulator layer in the workpiece, form a damage layer in the workpiece, or form bubbles or pockets within the workpiece. Thus, a single workpiece 26 is placed in the path of ribbon beam 24. This is distinct from batch implanters, such as a spinning disk implanter, when multiple workpieces are implanted together. SOI in single wafer implanters requires uniform ion distribution. This is met by using ribbon beam 24 with a one-dimensional scan. It may also be met using ribbon beam 24 with electrostatic or electromagnetic scanning. Uniform ion distribution may also be provided by a two-dimensional mechanical scan. However, this mechanical scan is limited by inertia and the beam may move slowly.

Certain single wafer implanters, such as single wafer ion implanter 10, are configured to greatly increase throughput for SOI implants compared to previous single wafer SOI implanters. This may be done, for example, by using a larger beam area or temperature control on the wafer or workpiece. For example, a single wafer implanter may use a ribbon beam for oxygen or hydrogen implants. Hydrogen doses for SOI implants may be approximately in the range of 5E16 cm⁻² and oxygen doses for SOI implants may be approximately in the range of 2E17 cm⁻², as examples.

Due to these high doses, a higher beam current to maintain a high throughput is required. A ribbon beam reduces “blowup” due to space charge at such a high beam current. A wafer or workpiece must also be cooled to accommodate such a high dose. Use of backside gas thermal coupling allows such a high dose for single wafer SOI implants.

Another requirement for SOI in single wafer implanters is a precise dose. This may involve high beam current or high power density. Thus, the single wafer implanter, such as single wafer ion implanter 10, must be able to keep the wafer or workpiece in a correct temperature range. This may be done with different embodiments of chuck 32.

Lastly, SOI in a single wafer implanter may require preheating the wafer or workpiece for oxygen implants before implantation to prevent amorphizing the silicon. This may be done with different embodiments of chuck 32. This may also be performed with at least one lamp.

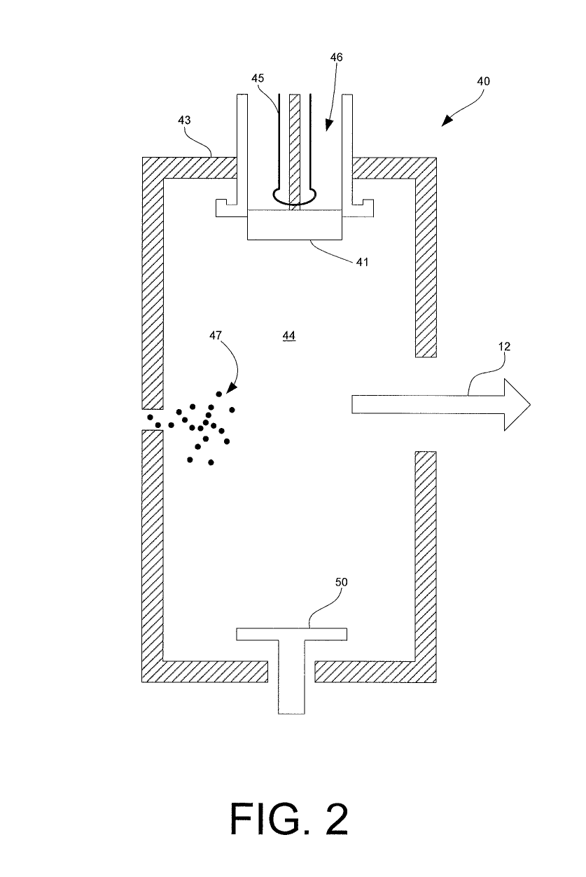

One such ion beam source 11 is an indirectly heated cathode 40. FIG. 2 is an embodiment of an indirectly heated cathode. This may be used for hydrogen, helium, oxygen, and nitrogen implants. This embodiment of indirectly heated cathode 40 comprises a cathode 41 configured to extend through wall 43 of arc chamber 44. Filament 45 is disposed adjacent cathode 41 in hollow area 46. Power supplies (not illustrated) heat filament 45, provide a bias voltage between filament 45 and cathode 41, and provide an arc voltage between cathode 41 and arc chamber 44.

When heated, filament 45 generates sufficient energy to emit electrons from a portion thereof that are propelled into hollow area 46 of cathode 41 by a bias voltage. Cathode 41 becomes hot as a result and eventually begins to emit electrons into arc chamber 44. Electrons are drawn into arc chamber 44 by an arc voltage so the electrons form a plasma when they impinge on gas molecules supplied by source gas 47. In some embodiments, spacing exists between cathode 41 and wall 43 to maintain a voltage gap. To utilize indirectly heated cathode 40, source gas 47 is introduced into arc chamber 44. Flow of source gas 47 through any spacing between cathode 41 and wall 43 is substantially restricted in some embodiments by keeping this spacing small. A restriction member may be used in some embodiments. Cathode 41 is heated to ionize source gas 47. Source gas 47 is ionized and ion beam 12 is generated.

To increase efficiency and ion generation, indirectly heated cathode 40 may be coupled with a repeller 50. The repeller 50 is a mechanical, electrostatic, or magnetic device that takes electrons generated by indirectly heated cathode 40 after the electrons transit across arc chamber 44 and reverses them to make another transit across arc chamber 44. This increases impacts between the electrons generated and source gas 47.

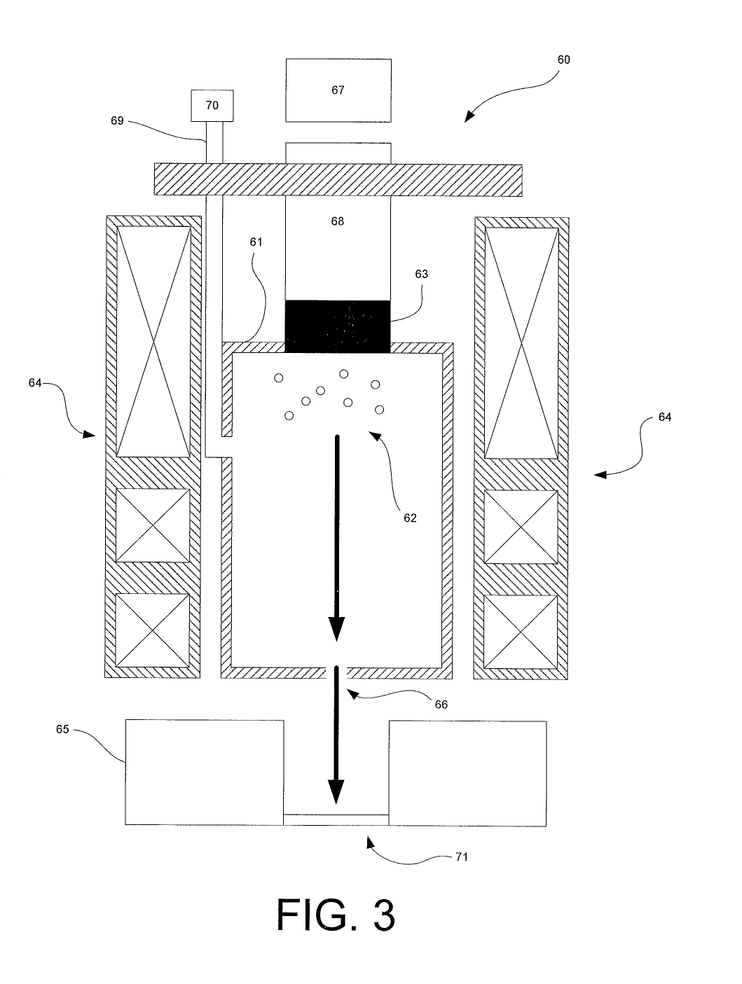

FIG. 3 is an embodiment of a microwave ion source. Microwave power may be used to create a plasma within ion beam source 11. Using microwave power removes the need for a filament or cathode. Thus, microwave power may have a long source life. One way to generate microwave power is to create an axial magnetic field of approximately 0.1 Tesla (1 kG) in the plasma chamber. The magnetic field created has a resonance condition given by the formula \acute{ω}_{c}=eB/m, wherein \acute{ω}_{c} is the cyclotron resonance frequency, e is the electron charge, B is the magnetic field, and m the electron mass.

In this particular embodiment, microwave ion source 60 is driven by a 2.45 GHz microwave generator 67 with a power of at least 500 W. This microwave generator 67 is a magnetron. An input power of 500 W may create a plasma with electron densities between approximately E12 to E13 cm⁻³. Extraction beam currents may be approximately 100 to 200 mA/cm² with plasma chamber 61 pressures in the sub mTorr range.

For a 2.45 GHz microwave generator, a frequency of a magnetic field of 8.75E⁻² Tesla satisfies the resonance condition for electrons. Operation of this magnetic field makes microwave ion source 60 an electron cyclotron resonance (ECR) source, however the available beam current may be increased by increasing the magnetic field above the resonance value.

Ions are produced in plasma chamber 61 of microwave ion source 60. Plasma chamber 61 is typically a water-cooled cylinder and in this embodiment has dimensions of approximately 2 to 5 cm in diameter and approximately 7 to 15 cm in length. Plasma chamber 61 may be made of materials such as aluminum or stainless steel and, in some embodiments, is double-walled. Making the plasma chamber 61 water-cooled limits microwave ion source 60 to producing ions from materials that do not condense on cool surfaces, such as H₂, He, N₂, or O₂. However, microwave ion source 60 may also be used on solid materials.

Microwave power is introduced to plasma 62 in plasma chamber 61 through dielectric window 63. Dielectric window 63 separates atmosphere from the lower pressure of plasma chamber 61. However, microwave power may also be introduced to plasma 62 through an antenna or other means known to those skilled in the art. Microwave power can be absorbed by plasma 62 because of the near resonance condition.

Dielectric window 63 is typically a plurality of materials, such as quartz, alumina, or boron nitride, selected to make a gradual transition from dielectric constant of air to that of plasma 62. The plurality of materials may be arranged in a sandwich, or layered, configuration. This gradual transition minimizes microwave reflected power. Source life of dielectric window 63 in this embodiment is determined by the final layer of the plurality of materials of the dielectric window 63 because it receives a bombardment of backstreaming electrons. This final layer of the dielectric window 63 may be replaced during preventive maintenance or source maintenance.

Waveguide 68 is disposed against dielectric window 63. Waveguide 68 may include a three stub tuner to minimize reflected power and will operate at a specific mode.

The axial magnetic field is produced by a plurality of solenoids 64 disposed around plasma chamber 61. Each solenoid 64 is typically comprised of several coils so that the magnetic field may be adjusted as a function of position within plasma chamber 61. Fine adjustment of solenoids 64 may be performed to maximize beam current and minimize beam noise.

Gas delivery system 69 typically delivers a gas flow to plasma chamber 61. In one example, this gas flow is as little as a few standard cubic centimeters per minute. Gas flow may come from a regulator 70. Other low pressure gas sources may be used, such as, for example, a “Safe Delivery System” container or other sources known to those skilled in the art.

Ions are generally extracted at the opposite end of plasma chamber 61 from where the microwave power is introduced. Thus, ions are usually extracted opposite of dielectric window 63. Extraction electrode assembly 65 is typically made of mild steel to minimize any fringing field in the region downstream of the plasma aperture 66, but extraction electrode assembly 65 may be made of other materials known to those skilled in the art.

Return steel 71 may be included in extraction electrode assembly 65 in some embodiments. Return steel 71 will short circuit the strong field internal to plasma chamber 61. Return steel 71 is composed of mild steel and will capture field lines because the field lines would rather pass through the steel than the vacuum. Return steel 71 assists in preventing any magnetic field near the extraction region which would deflect ions as they emerge from plasma chamber 61. In some embodiments, extraction electrode assembly 65 may also include a suppression and ground electrode.

In another embodiment, an RF ion source may be used for ion beam source 11. This RF ion generator creates radio frequency driven plasma, as known to those skilled in the art. This may be either an external antenna outside the plasma generating chamber or an internal antenna inside the plasma generating chamber. An RF ion source in one embodiment is inductively coupled.

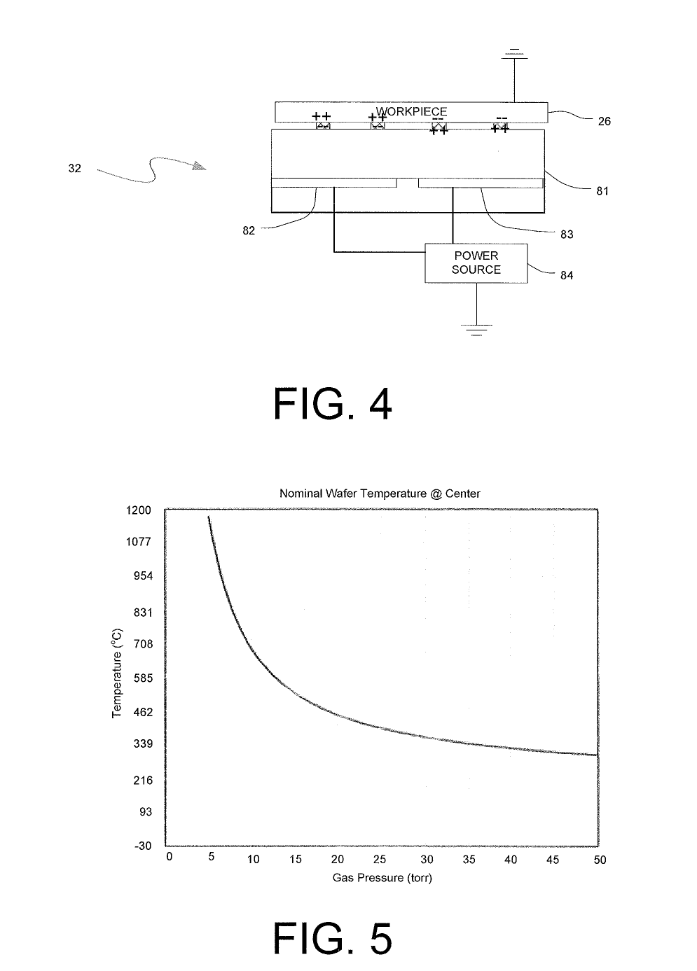

FIG. 4 shows an embodiment of an electrostatic chuck. Chuck 32 is used to secure and support workpiece 26 using electrostatic forces. Chuck 32 in this embodiment is configured for a single workpiece 26. SOI implants typically require a chuck, such as chuck 32, to be configured for implants above 100° C. Chuck 32, in some embodiments, is designed to minimize or eliminate bowing at such temperatures.

Chuck 32 in this embodiment has dielectric layer 81 and electrically conductive electrodes 82, 83. Although two electrodes 82, 83 are illustrated, chuck 32 may have only one electrode or more than two electrodes. Electrodes 82, 83 may be electrically connected to DC or AC power source 84

Electrostatic chucks, such as chuck 32, may generally be classified as either Coulombic or Johnsen-Rahbek types. One chuck may incorporate both Coulombic and Johnsen-Rahbek types. Each type of chuck may have a dielectric layer 81 positioned between the workpiece 26 and the electrodes 82, 83. An AC or DC voltage may be applied to the electrodes 82, 83.

Dielectric layer 81 may be fabricated of various insulator materials including, but not limited to, ceramic materials such as alumina. The dielectric layer for the Coulombic chuck is configured to not permit charge migration so that the charge on the Coulombic chuck always resides on the electrode and the workpiece being clamped. In contrast, the dielectric layer for the Johnsen-Rahbek chuck is configured to permit charge migration about the dielectric layer. The thickness of the dielectric layer, surface shape, and surface roughness of the dielectric layer may be factors that affect charge migration in a Johnsen-Rahbek chuck. This charge migration about the dielectric layer leads to an accumulation of charge at the workpiece-dielectric interface. Since the distance between the opposite charges is smaller in the Johnsen-Rahbek chuck compared to the Coulombic chuck, clamping pressure in the Johnsen-Rahbek chuck is greater for identical clamping voltages.

Typically, the doping level determines the temperature range that a chuck 32 can operate at. If chuck 32 is a Johnsen-Rahbek type chuck, the doping level can be modified so that the Johnsen-Rahbek effect works at different temperatures and the dielectric layer 81 conducts the correct current range. For example, O⁺ implants may be done at approximately 400° C. and also approximately 50° C. for touch-up implants. As another example, H⁺ implants may be done at room temperature. Thus, implants may be configured to allow the Johnsen-Rahbek effect.

With a clamping voltage of approximately 1 kV, a Johnsen-Rahbek type chuck permits backside gas pressures in the 30 to 50 torr range. This range permits a 20 kW oxygen ion (O⁺) beam to maintain a workpiece 26 temperature of 400° C., which is usually appropriate for a SIMOX implant. This is illustrated in FIG. 5, an example of a comparison of temperature to gas pressure for a chuck with backside gas.

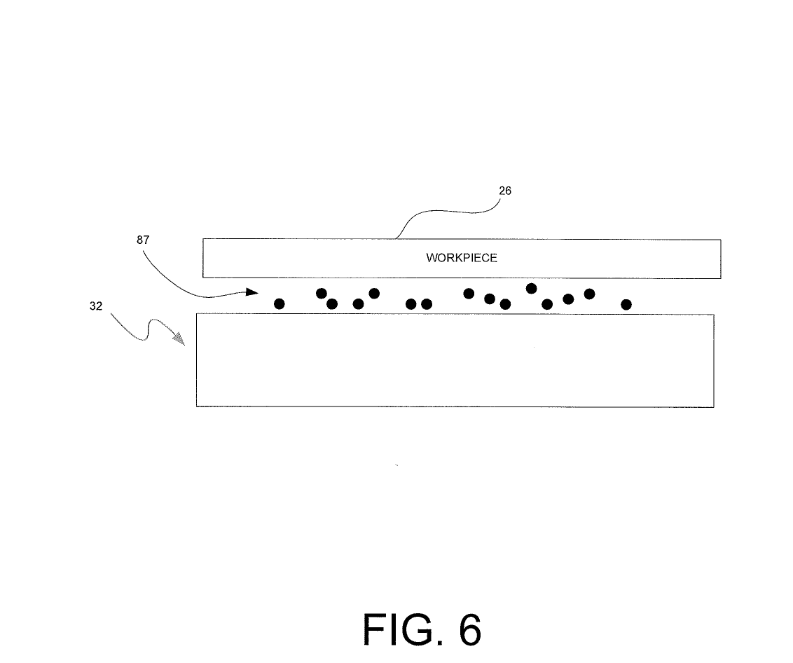

FIG. 6 is an embodiment of a chuck capable of performing backside gas thermal coupling. Chuck 32 may have a backside gas apparatus in some embodiments to perform backside gas thermal coupling. Here, gas atoms or molecules 87 flow between workpiece 26 and chuck 32. The gas atoms or molecules 87 strike the surface of chuck 32 and acquire translational and rotational energies corresponding to the temperature of chuck 32. This energy corresponding to the temperature of chuck 32 may be described using an accommodation coefficient that describes the coupling experienced between the atom or molecule 87 and the surface struck. An accommodation coefficient depends on details of the atom or molecule 87 (such as degrees of freedom) and the details of the surface that is struck (such as roughness or sticking coefficient).

The thermalized atom or molecule 87 then travels across the gap between workpiece 26 and chuck 32. If the distance between workpiece 26 and chuck 32 is small compared to the mean free path of the atom or molecule 87, or average distance traveled between collisions, the trip across the gap will be direct. When an atom or molecule reaches workpiece 26, the same thermalization process will occur with workpiece 26. If workpiece 26 is hotter than chuck 32, the atom or molecule 87 will absorb energy from workpiece 26. If chuck 32 is hotter than workpiece 26, then the atom or molecule 87 will absorb energy from chuck 32. As the atoms or molecules 87 travel between workpiece 26 and chuck 32, the two surfaces are brought toward the same temperature. In this manner, workpiece 26 may be either heated or cooled. This heat transfer may be made less efficient if there are large numbers of collisions between the gas atoms or molecules 87 because the atoms or molecules will then share energy between each other. In one embodiment, workpiece 26 is heated or cooled to between approximately 300° C. and 600° C.

In one example, at approximately 15 torr the mean free path for N₂ molecules is about 20 μm. A higher gas pressure would mean more atoms to transfer heat between workpiece 26 and chuck 32, but would also mean a shorter mean free path. Thus, at low pressure heat transfer is proportional to gas pressure. As pressure rises to a point where mean free path drops to the chuck-workpiece separation, the increase will start to fall off. Higher pressure may be used by keeping workpiece 26 nearer to chuck 32. In most cases, clamping pressure must be higher than backside gas pressure.

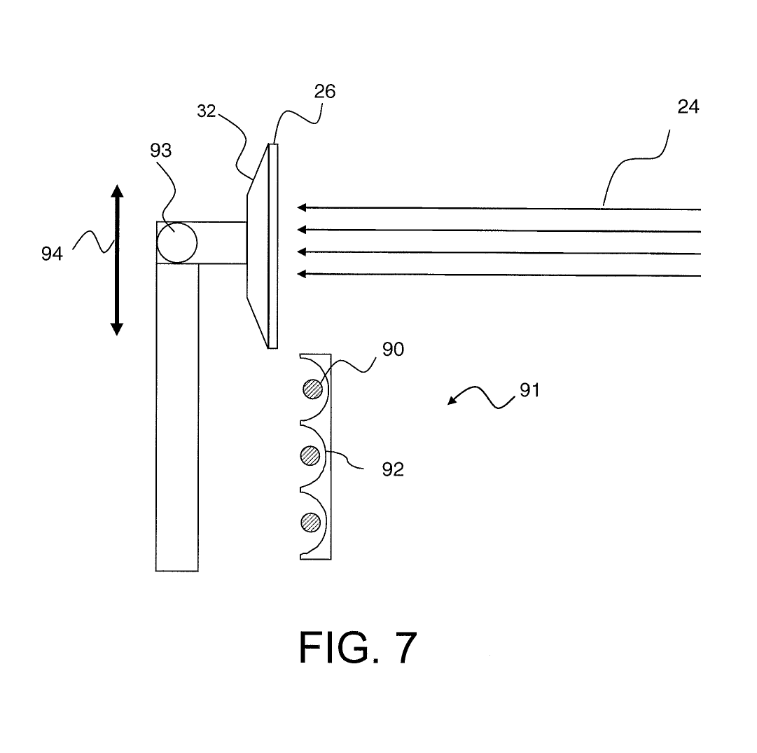

A heat source external to the chuck could also be used to heat workpiece 26. FIG. 7 is an embodiment of an apparatus using lamps to heat a wafer. The interface between workpiece 26 and chuck 32 may be operated with or without backside gas in this embodiment.

The workpiece 26 reflects or absorbs much of the heat. Some heat is transmitted, but the dielectric of the chuck 32 may not get as hot as the workpiece 26. The heat source may be at least one lamp 90, such as a 2 kW QIH-240-2000 manufactured by Ushio. The heat source could also be a laser of various wavelengths. For example, infrared may be chosen at a wavelength that is efficiently absorbed by the workpiece 26 to heat workpiece 26.

A lamp array 91 is shown with three lamps 90 in this embodiment. Another embodiment has eleven lamps 90 to evenly heat the workpiece 26. These are linear lamps, arranged above each other, but they could be circular bulbs and arranged in circular arrays or other configurations known to those skilled in the art. The lamps 90 are mounted in front of reflectors 92.

In this embodiment the lamps 90 are below the ribbon beam 24 trajectory, heating the workpiece 26 when it is in a vertical position. A horizontal heating orientation could be chosen so that the workpiece 26 could be declamped, mitigating backside damage. The lamps 90 could be above the ribbon beam 24, both above and below the ribbon beam 24, or could shine the heat onto the same place as the ribbon beam 24 hits the workpiece 26. Ion implantation is carried out using ribbon beam 24 in this embodiment, but the same process could be used with other forms of ion implantation. In one embodiment, lamps 90 heat workpiece 26 to between approximately 300° C. and 600° C.

Photoresist residue may coat lamps 90 during regular implants. This may not occur during hot implants because solid masks may be used, while polymer-based photoresist degrades above 100° C. To avoid this problem in some embodiments, the lamp array 91 may have covers for performing conventional room temperature implants, or may be mechanically moved so that vapor from photoresist outgassing cannot condense on lamps 90 or reflectors 92. The lamps 90 may be configured to be heated to burn off contamination deposited on lamps 90 and reflectors 92 in one embodiment. Alternatively, the temperature of the lamps 90 could be continuously maintained above the temperature at which the vapors condense in another embodiment.

Workpiece 26 is disposed on chuck 32. Chuck 32 is translated by scanner mechanism 93 in the direction 94 in this embodiment. Direction 94 will move workpiece 26 and chuck 32 from the path of ribbon beam 24 to a position used for heating by lamp array 91.

The terms and expressions which have been employed herein are used as terms of description and not of limitation. There is no intention in the use of such terms and expressions of excluding any equivalents of the features shown and described (or portions thereof), and it is recognized that various modifications are possible within the scope of the claims. Other modifications, variations, and alternatives are also possible. Accordingly, the foregoing description is by way of example only and is not intended as limiting.

What is claimed is:

1. An ion implanter comprising:
an ion beam source configured to generate ions selected from a group consisting of oxygen and nitrogen into an ion beam with a dose range selected from a group consisting of oxygen at approximately 1E17 to 4E17 cm⁻², oxygen at approximately 1 to 3E15 cm⁻², and nitrogen at approximately 1E17 to 2E18 cm⁻²;
an analyzer magnet configured to remove undesired species from said ion beam; and
an electrostatic chuck having a backside gas thermal coupling, said electrostatic chuck configured to hold a single workpiece for silicon-on-insulator implantation by said ion beam with said dose range, said electrostatic chuck configured to cool said workpiece to a temperature in a range of approximately 300° C. to 600° C.

2. The ion implanter of claim 1, wherein said ion beam is a ribbon beam and said electrostatic chuck is configured to perform a one-dimensional scan of said single workpiece.

3. The ion implanter of claim 1, wherein said ion beam source comprises an indirectly heated cathode ion source.

4. The ion implanter of claim 1, wherein said ion beam source comprises a microwave ion source.

5. The ion implanter of claim 1, wherein said ion beam source comprises an inductively coupled RF ion source.

6. The ion implanter of claim 1, wherein said ion implanter is configured to preheat said single workpiece before implantation to a temperature in a range of approximately 300° C. to 600° C.

7. The ion implanter of claim 6, wherein said electrostatic chuck is configured to preheat said single workpiece.

8. The ion implanter of claim 6, wherein said ion implanter further comprises at least one lamp, said lamp configured to preheat said single workpiece.

9. The ion implanter of claim 1, wherein said backside gas thermal coupling provides at least approximately 15 torr backside gas pressure.

10. An ion implanter comprising:
an ion beam source configured to generate ions selected from a group consisting of hydrogen and helium into an ion beam having a dose range selected from the group consisting of hydrogen at approximately 5E15 to 8E16 cm⁻² and helium at approximately 5E15 to 8E16 cm⁻²;
an analyzer magnet configured to remove undesired species from said ion beam; and
an electrostatic chuck having a backside gas thermal coupling, said electrostatic chuck configured to hold a single workpiece for silicon-on-insulator implantation by said ion beam with said dose range, said electrostatic chuck configured to cool said workpiece to a temperature in a range of approximately 300° C. to 600° C.

11. The ion implanter of claim 10, wherein said ion beam is a ribbon beam and said electrostatic chuck is configured to perform a one-dimensional scan of said single workpiece.

12. The ion implanter of claim 10, wherein said ion beam source comprises an indirectly heated cathode ion source.

13. The ion implanter of claim 10, wherein said ion beam source comprises a microwave ion source.

14. The ion implanter of claim 10, wherein said ion beam source comprises an inductively coupled RF ion source.

15. The ion implanter of claim 10, wherein said ion implanter is configured to preheat said single workpiece before implantation to a temperature in a range of approximately 300° C. to 600° C.

16. The ion implanter of claim 15, wherein said electrostatic chuck is configured to preheat said single workpiece.

17. The ion implanter of claim 15, wherein said ion implanter further comprises at least one lamp, said lamp configured to preheat said single workpiece.

18. The ion implanter of claim 10, wherein said backside gas thermal coupling provides at least approximately 15 torr backside gas pressure.

19. A method for silicon-on-insulator implantation in a single wafer ion implanter comprising:
generating an ion beam selected from a group consisting of hydrogen at a dose of approximately 5E15 to 8E16 cm⁻², helium at a dose of approximately 5E15 to 8E16 cm⁻², oxygen at a dose of approximately 1E17 to 4E17 cm⁻², oxygen at a dose of approximately 1 to 3E15 cm⁻², and nitrogen at a dose of approximately 1E17 to 2E18 cm⁻²;
analyzing said ion beam to remove undesired species;
substantially retaining a single workpiece for silicon-on-insulator fabrication on an electrostatic chuck having backside gas thermal coupling;
implanting said single workpiece with said ion beam; and
cooling said single workpiece to a temperature in a range of approximately 300° C. to 600° C. using said electrostatic chuck.

20. The method of claim 19, wherein said ion beam is generated with an indirectly heated cathode ion source.

21. The method of claim 19, wherein said ion beam is generated with a microwave ion source.

22. The method of claim 19, wherein said ion beam is generated with an inductively coupled RF ion source.

23. The method of claim 19, wherein said method further comprises preheating said single workpiece to a temperature in a range of approximately 300° C. to 600° C. using said electrostatic chuck.

24. The method of claim 19, wherein said method further comprises preheating said single workpiece to a temperature in a range of approximately 300° C. to 600° C. using at least one lamp.

25. The method of claim 19, wherein said ion beam is a ribbon beam and implanting said single workpiece with said ribbon beam is performed by a one-dimensional scan of said workpiece.
